(19) United States
(12) Patent Application Publication
(10) Pub. No.: US 2015/0355465 A1
(43) Pub. Date: Dec. 10, 2015

(54) HEAD MOUNTED DISPLAY FRAME FOR IMPROVED SPATIAL PERFORMANCE IN HEAD MOUNTED VIRTUAL ENVIRONMENTS

(71) Applicant: University of Southern California, Los Angeles, CA (US)

(72) Inventors: J. Adam Jones, Seneca, SC (US); Mark Bolas, Los Angeles, CA (US); David M. Krum, Arcadia, CA (US)

(73) Assignee: University of Southern California, Los Angeles, CA (US)

(21) Appl. No.: 14/211,459

(22) Filed: Mar. 14, 2014

Related U.S. Application Data
(60) Provisional application No. 61/785,843, filed on Mar. 14, 2013.

(51) Int. Cl. G02B 27/01; G02B 27/22; H04N 13/04

(52) U.S. Cl. CPC G02B 27/0172; H04N 13/044; G02B 27/2214; G02B 2027/0118; G02B 2027/0134

(57) ABSTRACT

A head-mounted display allows the user to view a virtual environment. The head-mounted display is made of a pair of lenses which is directed to a display encased within a housing. However, the display provides a limited field-of-view that is less than what the user sees in a real-world environment. Adding an illuminated frame around the display's periphery can enable the user to produce spatial judgment similar to having a larger field-of-view. The illuminated frame does not require additional processing.

### CROSS-REFERENCE TO RELATED APPLICATION[S]

This application is based upon and claims priority to U.S. provisional patent application 61/785,843, entitled “Head Mounted Display Technique Frame For Improved Spatial Performance In Head Mounted Virtual Environments,” filed Mar. 14, 2013, attorney docket number 028080-0855. The entire content of each of this application is incorporated herein by reference.

### STATEMENT REGARDING FEDERALLY SPONSORED RESEARCH

This invention was made with government support under Grant No. W911 NF-04-D-0005, awarded by the Army Research Office. The government has certain rights in the invention.

### BACKGROUND

1. Technical Field

This disclosure relates to a head-mounted display for viewing a virtual environment.

2. Description of Related Art

U.S. Pat. No. 8,212,859, issued Jul. 3, 2012 to Tang et al., entitled “Peripheral Treatment of Head-Mounted Displays,” describes a colored treatment applied around the edges of a head-mounted display's screen that is processed by an intermediate controller to match the color of the pixels rendered in the display area

Philips Electronics NV markets Ambilight which provides ambient illumination surrounding a standard display screen, such as a television. This display screen is described in EP 1379082, titled “Display Apparatus”; WO 2004006570, titled “Method of and System for Controlling an Ambient Light and Lighting Unit”; WO 2005041568, titled “Automatic Display Adaptation to Lighting”; WO 2005069640, titled “Ambient Light Script Command Encoding”; WO 2004006578, titled “Flicker-free Adaptive Thresholding for Ambient Light Derived from Video Content Mapped through Unrendered Color Space”; WO 2006003624, titled “Ambient Lighting Derived from Video Content and with Broadcast Influenced by Perceptual Rules and User Preferences”; WO 2006003603, titled “Passive Diffuser Frame System for Ambient Lighting Using a Video Display Unit as a Light Source”; WO 2006003604, titled “Active Frame System for Ambient Lighting Using a Video Display as a Signal Source”; and WO 2006003600, titled “Dominant Color Extraction Using Perceptual Rules to Produce Ambient Light Derived from Video Content.”

### SUMMARY

The present disclosure is directed to enhancing the performance of a head-mounted display (HMD) for viewing a virtual environment. The head-mounted display may be a stereoscopic viewing device for viewing stereoscopic graphics of the virtual environment. An illuminated frame is placed in the user's periphery independent of the display's contents with no need for intermediate processing of pixels rendered to the display or other consideration for the contents of the screen area or screen context. The frame may be implemented through an active display, or may be implemented in other ways, such as a physically illuminated static mechanical light.

In one implementation, a virtual environment viewing device comprises a display, an optics component oriented towards the display, a housing connected to the display and the optics component and configured to exclude at least a portion of ambient light external to the housing, and an illuminated frame connected to the housing and configured to illuminate a periphery of the display.

In another implementation, a head-mounted display comprises a display, an optics component oriented towards the display, a housing connected to the display and the optics component and configured to exclude at least a portion of ambient light external to the housing, an attachment configured to attach the housing to a user's head, and an illuminated frame connected to the housing and configured to illuminate a periphery of the display.

In yet another implementation, a stereoscopic head-mounted display comprises a left display, a right display, a left optics component oriented towards the left display, a right optics component oriented towards the right display, a housing connected to the left display, the right display, the left optics component, and the right optics component, a left illuminated frame connected to the housing and configured to illuminate a periphery of the left display, and a right illuminated frame connected to the housing and configured to illuminate a periphery of the right display.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a view of a virtual environment and a peripheral frame drawn on a polar coordinate system representing a field of view of a human according to example aspects of the present disclosure.

FIG. 2 illustrates an illuminated frame using LEDs according to example aspects of the present disclosure.

FIG. 3 illustrates the LED illuminated frame of FIG. 2 with a head-mounted display, in which the frame is placed between the lenses and the user's eyes according to example aspects of the present disclosure.

FIG. 4 illustrates the LED illuminated frame FIG. 2 with a head-mounted display, in which the frame is placed between the lenses and the display panel according to example aspects of the present disclosure.

FIG. 5 illustrates a single strip of a passive illuminated frame according to example aspects of the present disclosure.

FIG. 6 illustrates a passive illumination frame comprising a plurality of strips from FIG. 5 according to example aspects of the present disclosure.

FIG. 7 illustrates the passive illuminated frame FIG. 6 with a head-mounted display according to example aspects of the present disclosure.

FIG. 8 illustrates an illuminated frame comprising an electroluminescent wire according to example aspects of the present disclosure.

FIG. 9 illustrates the illuminated frame of FIG. 8 with a head-mounted display according to example aspects of the present disclosure.

FIG. 10 illustrates an illuminated frame comprising an electroluminescent wire inside a head-mounted display according to example aspects of the present disclosure.

### DETAILED DESCRIPTION

Illustrative embodiments are now discussed and illustrated. Other embodiments may be used in addition or instead. Details which may be apparent or unnecessary may be omitted to save space or for a more effective presentation. Conversely, some embodiments may be practiced without all of the details that are disclosed.

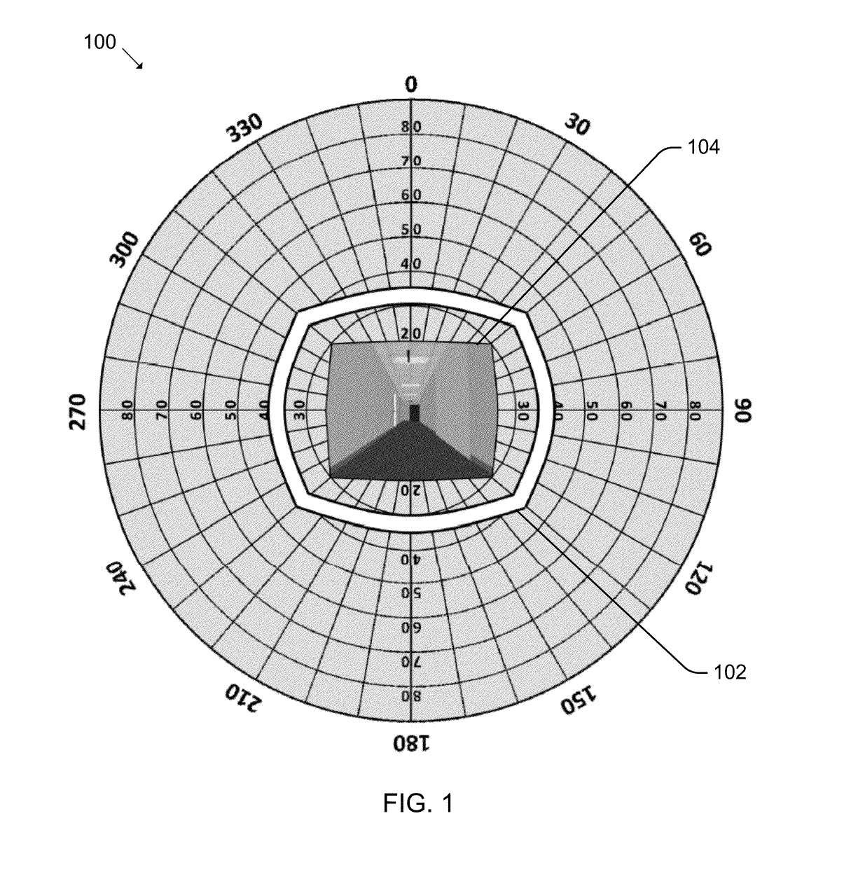

FIG. 1 illustrates a polar representation of a user's field of view 100 of a virtual environment 104. According the present inventive concepts, the presentation of a head mounted virtual environment may be enhanced such that users of a small field-of-view head-mounted virtual environment appear to more accurately perform spatial judgments. A frame 102, which may be white, is shown outside of the central display area of the head-mounted display in the user's periphery at, for example, ±40°×±36.5° from the center of vision (80°×73° span). The frame 102 extends inward 5° toward the center of vision. A typical virtual environment 104 of 48°×40° is then displayed at the center of vision. This frame 102 has been demonstrated to produce spatial judgments in a 48°×40° field-of-view virtual environment that do not significantly differ from those in 150°×88° field-of-view virtual environment.

The present inventive concepts utilize a stationary frame of light that surrounds the view of a head mounted virtual environment. The field of view of a virtual environment is typically restricted to some small, but easily engineered extent, such as 60°, 90°, 120° or other value. However, most normally sighted people have a field of view of nearly 180° across. Restricted fields of view, as typical in virtual environments, negatively affect users' ability to accurately walk, judge their movements, and understand where objects are in the environment. Increasing the field of view of a head mounted display improves performance but also increases the complexity and expense of designing and manufacturing the display. The use of an illuminated frame may enable users of a small field of view head mounted virtual environment to walk, judge their movements, and understand spatial relationships in a manner comparable to users of a large field of view head mounted virtual environment, or perceive such judgment and understanding in a manner comparable to users of a larger field of view. However, due to the subjective nature of human perception, the user may or may not actually perceive these or other benefits.

FIG. 1 shows an illuminated white frame 102 in the user's periphery such that it surrounds the small field of view of a virtual environment 104. This has been tested using a 48°×40° (60° diagonal) virtual environment with an illuminated, white frame surrounding the environment at 80°×73° of field of view and extending inward 5°. The arrangement of the view of the virtual environment and the frame are illustrated in FIG. 1. The frame can be graphically rendered as part of the display or can be physically implemented using LEDs and light conductive materials, and may be white or any other color, such as red, green, blue, yellow, etc.

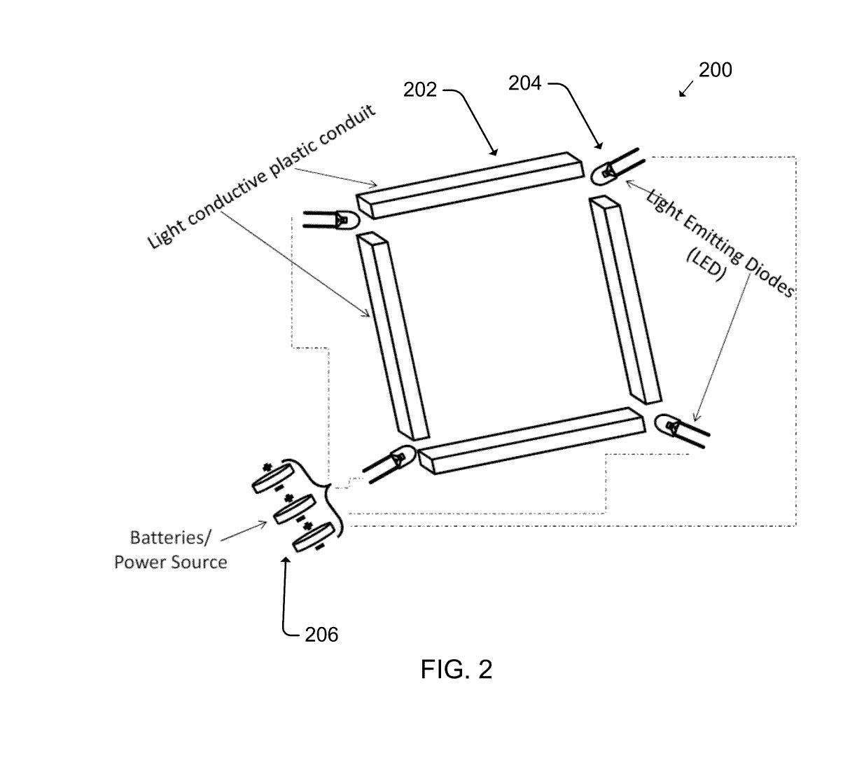

FIG. 2 illustrates an implementation of a physically constructed illuminated frame. Because screen space in a head mounted virtual environments may be physically limited, a physically constructed illuminated frame may be appropriate. FIG. 2 illustrates how one implementation of a frame 200 may be constructed. The frame 200 is constructed of simple, off-the-shelf materials such as white LEDs 204, power source 206, which may be one or more watch batteries or other suitable power source, and conduit 202, a light conductive conduit which may be white plastic such as a drinking straw.

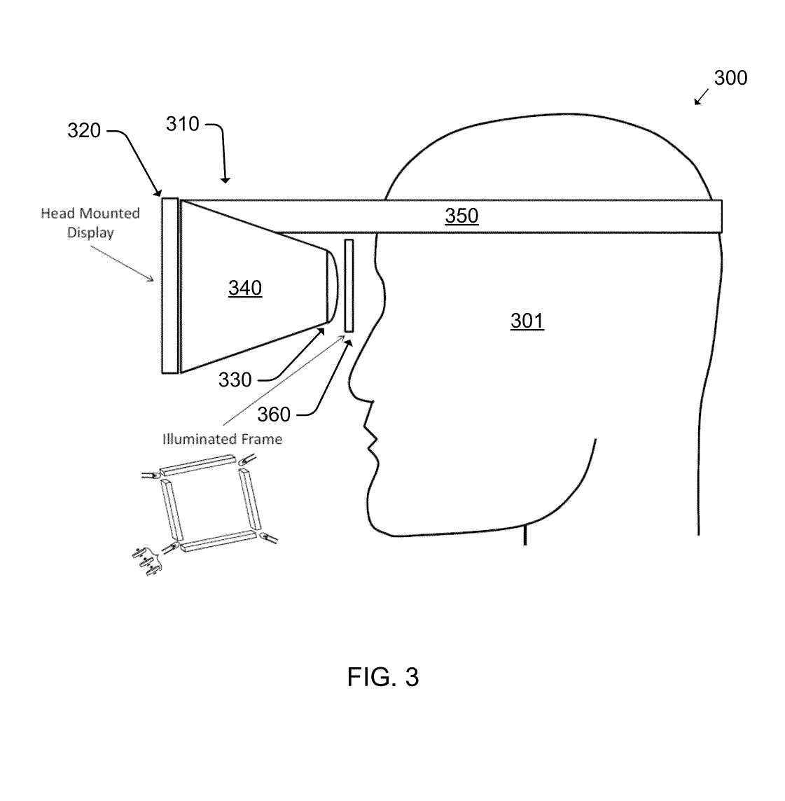

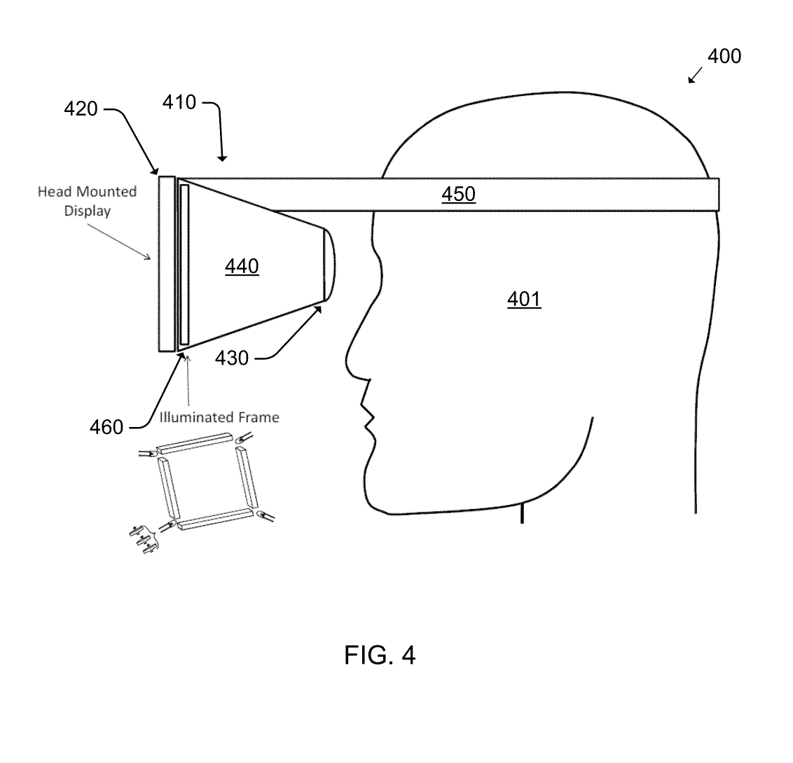

FIGS. 3 and 4 illustrate how a frame similar to the frame 200 may be used with a head mounted virtual environment. In FIG. 3, a head mounted virtual environment 300 includes a user 301 and a head-mounted display (HMD) 310. The HMD 310 includes a display 320, an optics component 330, a housing 340, an attachment 350, and an illuminated frame 360. The display 320 may be a flat display (FD), which may be a stereoscopic display, an LCD display, or other display. The optics component 330 may be a lens, or a pair of lenses for stereoscopic vision, or other optical viewing instrument, or may be a hollow portion or portions of the housing 340, and is oriented towards the display 320. The housing 340 connects the display 320 and the optics component 330, may be at least partially opaque, and may be further configured to exclude some or all ambient light external to the housing 340. The attachment 350 attaches the HMD 310 to the user 301, and may be a strap or other similar attachment. In alternative implementations, the HMD 310 may be a head coupled display without the attachment 350. Instead of an attachment to the user's head, the HMD 310 may be held up to the user's head, similar to binoculars. The illuminated frame 360 may be similar to the frame 200, and may further comprise a pair of frames 200 for stereoscopic vision. The frame 360 may alternatively comprise other illuminated frame configurations. The frame 360 is placed between the optics component 330 and the user 301, for example near eyes of the user 301, distal from the display 320.

In FIG. 4, a head mounted virtual environment 400 includes a user 401 and an HMD 410. The HMD 410 includes a display 420, an optics component 430, a housing 440, an attachment 450, and an illuminated frame 460. The display 420 may be a FD, which may be a stereoscopic display, an LCD display, or other display. The optics component 430 may be a lens, or a pair of lenses for stereoscopic vision, or other optical viewing instrument, or may be a hollow portion or portions of the housing 440, and is oriented towards the display 420. The housing 440 connects the display 420 and the optics component 430, may be at least partially opaque, and may be further configured to exclude some or all ambient light external to the housing 440. The attachment 450 attaches the HMD 410 to the user 401, and may be a strap or other similar attachment. In alternative implementations, the HMD 410 may be a head coupled display without the attachment 450. The illuminated frame 460 may be similar to the frame 200, and may further comprise a pair of frames 200 for stereoscopic vision. The frame 460 may alternatively comprise other illuminated frame configurations. The frame 460 is placed between the optics component 430 and the display 420, for example near the display 420.

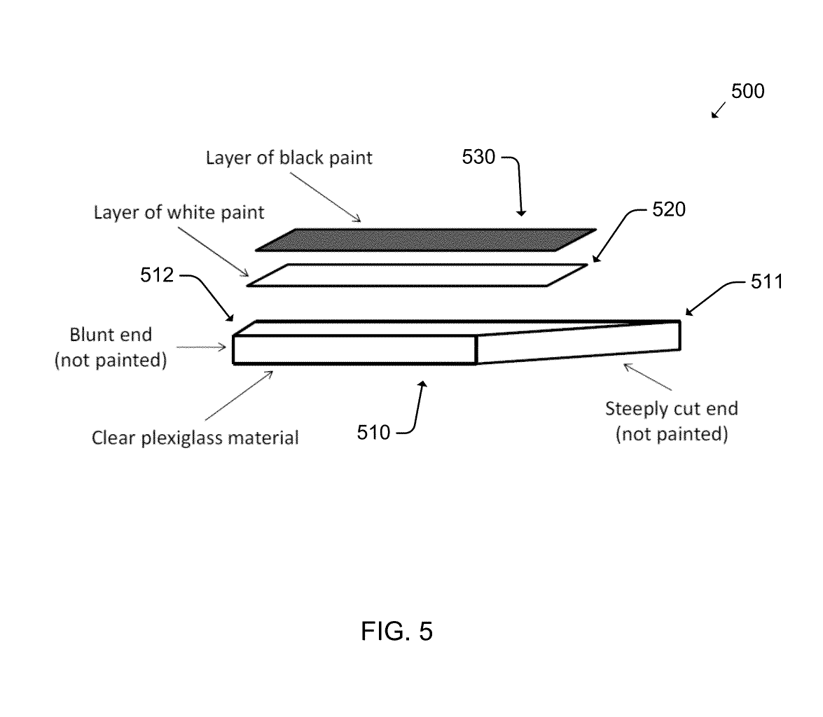

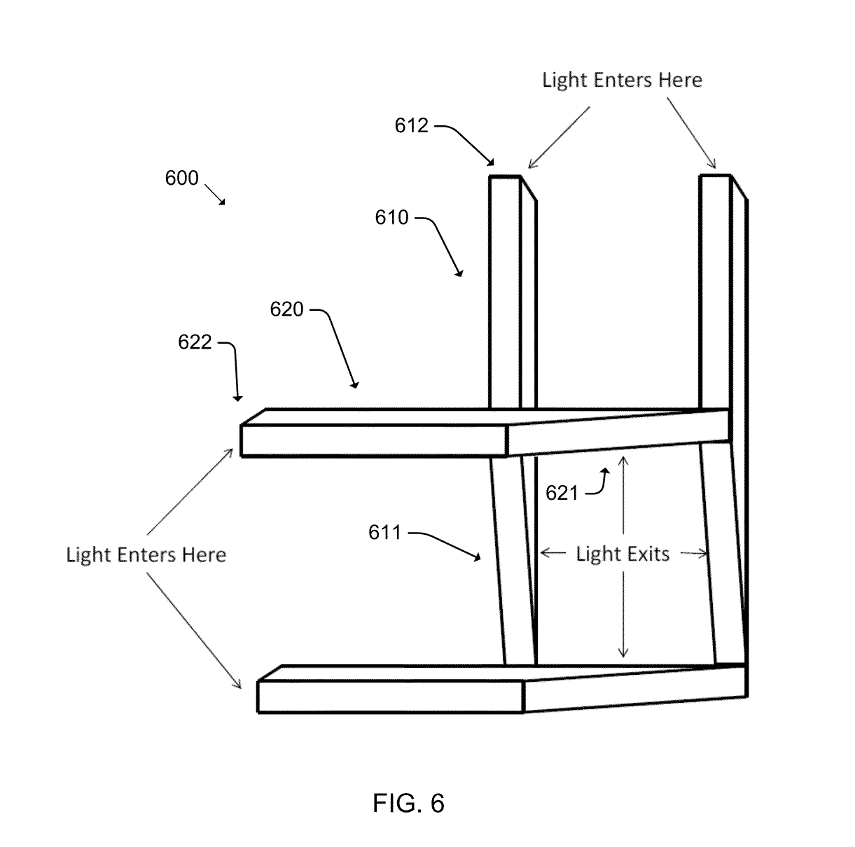

In another implementation, an illuminated frame uses passive illumination of the frame using light pipes to direct light from the surrounding real world environment into the user's periphery. A battery or electrical power is not required when using passive illumination. Additionally, this implementation can provide the user with passive changes in the light level as the user moves, thereby providing the user with visual flow. Passive visual flow in the periphery has been shown to provide users with improved performance and experiences in head mounted virtual environments. This implementation can be constructed from parts made of acrylic, or similar material, and paint, or other similar non-transparent coverings. FIGS. 5 and 6 depict construction of an implementation using passive illumination.

In one implementation, a light pipe may be constructed by cutting a strip of acrylic, plexiglass, or similar material into four rectangular strips 510, and then cutting one of the shorter ends 511 at a steep angle. The steep angle may be, for example, less than 45 degrees. The other end 512 remains blunt or flat. The strips 510 are then painted with a white paint 520 except the blunt end 512 and angled end 511. A second coat of black paint 530 is then applied on top of the white paint 520. The strips 510 are then arranged into a frame.

FIG. 6 illustrates one possible arrangement of strips 610 and 620, which may correspond to the strip 510, to form a frame 600. Two strips 610 are placed first, with blunt ends 612 facing outward and angled ends 611 facing inward. Two strips 620 are placed over the strips 610, with angled ends 621 near angled ends 611, and blunt ends 622 facing outward. The frame 600 is then placed, just as in the previous implementation, such that it surrounds the view into the virtual environment. Although in FIG. 6 the strips 610 and 620 are arranged in a rectangular or square shape, in other implementations other polygonal shapes using straight strips, or other shapes using curved strips.

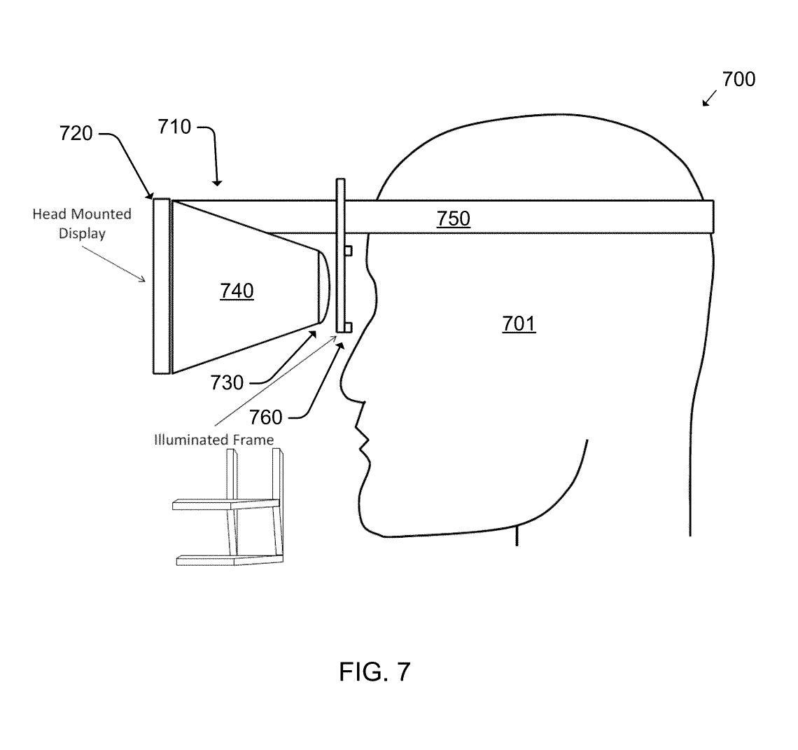

FIG. 7 illustrates how this implementation would be used with a head mounted virtual environment 700. The head mounted virtual environment 700 includes a user 701 and an HMD 710. The HMD 710 includes a display 720, an optics component 730, a housing 740, an attachment 750, and an illuminated frame 760. The display 720 may be an FD, which may be a stereoscopic display, an LCD display, or other display. The optics component 730 may be a lens, or a pair of lenses for stereoscopic vision, or other optical viewing instrument, or may be a hollow portion or portions of the housing 740, and is oriented towards the display 720. The housing 740 connects the display 720 and the optics component 730, may be at least partially opaque, and may be further configured to exclude some or all ambient light external to the housing 740. The attachment 750 attaches the HMD 710 to the user 701, and may be a strap or other similar attachment. In alternative implementations, the HMD 710 may be a head coupled display without the attachment 750. The illuminated frame 760 may be similar to the frame 600, and may further comprise a pair of frames 600 for stereoscopic vision. The frame 760 may alternatively comprise other illuminated frame configurations. The frame 760 is placed between the optics component 730 and the user 701, for example near eyes of the user 701, distal from the display 720. In other implementations the frame 760 may be placed between the optics component 730 and the display 720, similar to FIG. 4.

In another alternative implementation, white light can be harvested from the backlight of the display panel using light pipes to passively illuminate the frame. The light pipes may be constructed as described above, but designed to redirect light from the rear of the display panel, where many flat panel display panels use LEDs or Cold Cathode Fluorescent Lamps (CCFL) to produce white light, which is filtered by individual pixels of the display to render the color palette available in the display. Other display technologies that use similar back illumination sources, such as Digital Light Projection (DLP), can also be utilized for passive frame illumination.

Alternatively, light from a set of pixels from the display panel can be redirected into light pipes to illuminate the frame. These pixels would not be visible to the user and would only contribute to providing light to the illuminated frame.

In implementations where passive illumination is used, user motion can induce variation in the brightness of the frame, which can provide visual flow as a peripheral motion cue. This can be achieved naturally as ambient light can vary as a user moves through physical space. It can also be achieved by passing the illumination through optics, such as shutters or materials whose transparency can be controlled by a signal. When active illumination is used, brightness can be varied as user movement is sensed or as the user commands movement through a virtual scene using a joystick, mouse, or other input device.

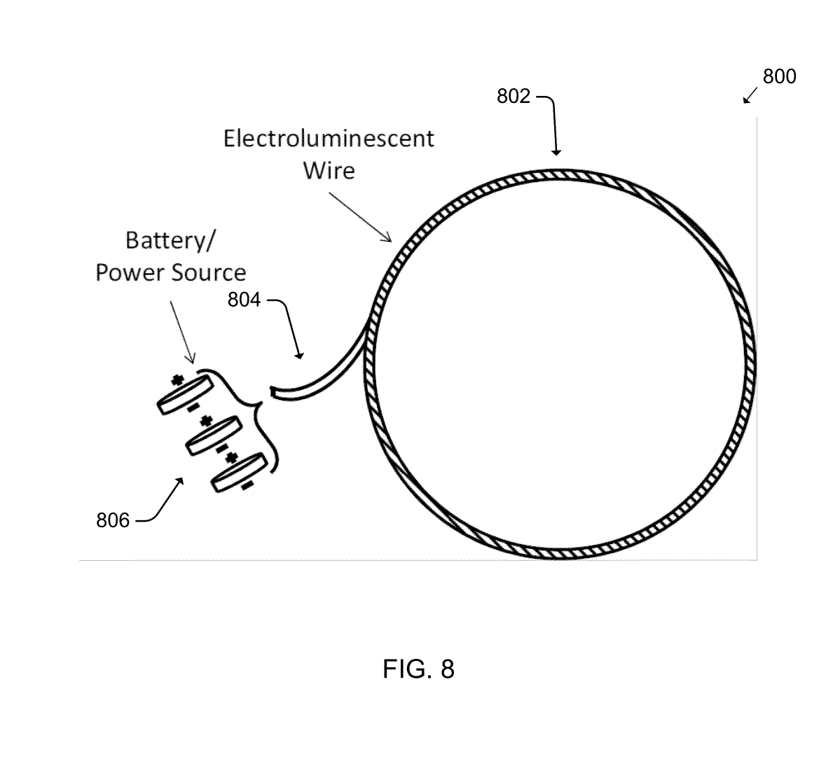

FIG. 8 illustrates an implementation using a frame 800 constructed of electroluminescent wire 802 to form the illuminated frame 800 around the small field of view of a virtual environment. The frame 800 of electroluminescent wire 802 has a shape configured to surround the field of view in a manner similar to those discussed above. Small batteries or other power source 806 is electrically connected to a connection wire 804 of the electroluminescent wire 802 to power the electroluminescent wire 802. Although the frame 800 is shown in an elliptical or circular shape, in other implementation, other shapes may be used.

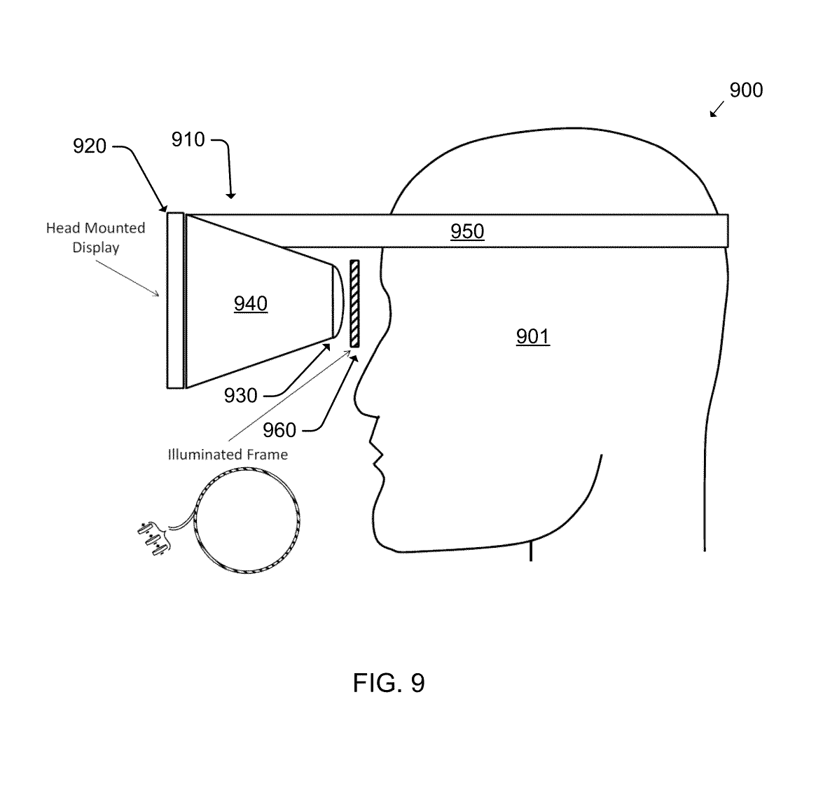

FIG. 9 illustrates how an electroluminescent wire frame 960 is used in a head mounted virtual environment 900. The head mounted virtual environment 900 includes a user 901 and an HMD 910. The HMD 910 includes a display 920, an optics component 930, a housing 940, an attachment 950, and an illuminated frame 960. The display 920 may be an FD, which may be a stereoscopic display, an LCD display, or other display. The optics component 930 may be a lens, or a pair of lenses for stereoscopic vision, or other optical viewing instrument, or may be a hollow portion or portions of the housing 940, and is oriented towards the display 920. The housing 940 connects the display 920 and the optics component 930, may be at least partially opaque, and may be further configured to exclude some or all ambient light external to the housing 940. The attachment 950 attaches the HMD 910 to the user 901, and may be a strap or other similar attachment. In alternative implementations, the HMD 910 may be a head coupled display without the attachment 950. The illuminated frame 960 may be similar to the frame 800, and may further comprise a pair of frames 800 for stereoscopic vision. The frame 960 may alternatively comprise other illuminated frame configurations. The frame 960 is placed between the optics component 930 and the user 901, for example near eyes of the user 901, distal from the display 920. In other implementations the frame 960 may be placed between the optics component 930 and the display 920, similar to FIG. 4.

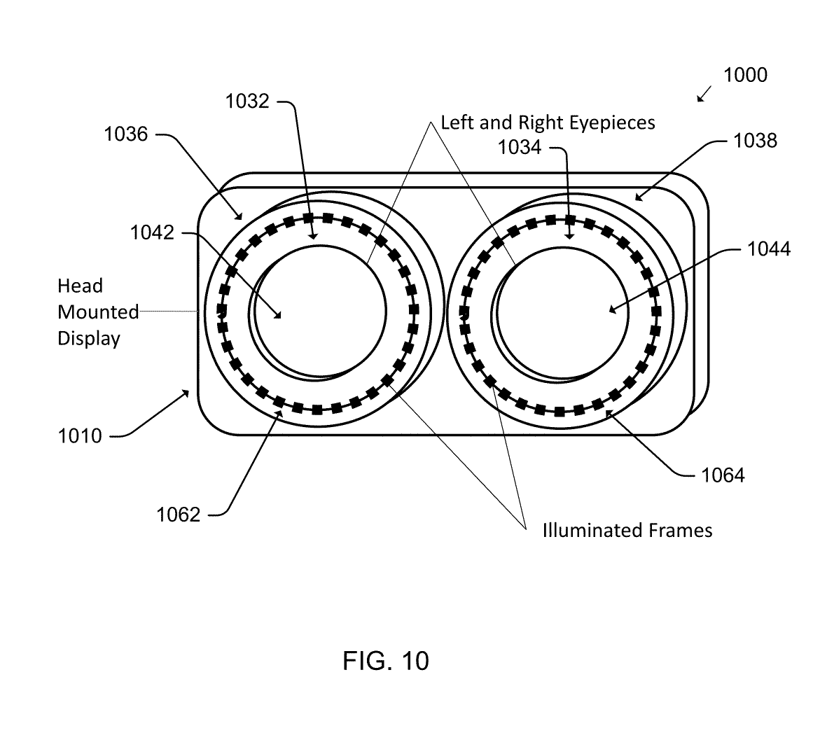

FIG. 10 depicts a virtual environment viewing device 1000. The virtual environment viewing device 1000 includes a left display 1042, a right display 1044, a housing 1010, which includes a left eye frame 1036 for holding a left eyepiece 1032, and a right eye frame 1038 for holding a right eyepiece 1034. The left eye frame 1036 also holds a left illuminated frame 1062, which may be similar to the frame 800, or may correspond to any other illuminated frame similar to those described above. The right eye frame 1038 also holds a right illuminated frame 1064, which may be similar to the frame 800, or may correspond to any other illuminated frame similar to those described above. The illuminated frames 1062 and 1064 surround the eyepieces 1032 and 1034, respectively. The left eye frame 1036 is oriented towards the left display 1042 such that the left display 1042 may be visible through the left eye frame 1036. The right eye frame 1038 is oriented towards the right display 1044 such that the right display 1044 may be visible through the right eye frame 1038. The left display 1042 and the right display 1044 may be two separate displays, may be different sections of the same display, may be a single display configured to display separate images for each eye, or any other stereoscopic or 3D display. The virtual environment viewing device 1000 may be a head coupled display.

It is important to note the frame could also be square, rectangular, circular, oval, or other shape. The frame may also be of varying dimensions other than those used in the above description and may be larger than the lens through which the virtual environment is viewed. The illumination source also need not be LEDs, electroluminescent materials, or natural light, but could include similar light sources. The light conducting conduit used with the LED implementation also does not necessary have to be white or plastic. It only needs to be a material with properties sufficient to conduct light internally or along its surface. The light pipe used in the passive frame description does not necessarily need to be made of acrylic but could also be made of any material with sufficient properties to conduct light along its length. The colors of the paint used in this implementation also does not by necessity need to be black and white, but may be any suitable color. It is also important to note that powering the illuminated frame is not exclusive to batteries but may be implemented with any suitable source of power, such as USB or solar.

The illumination of peripheral light can provide other benefits that have not been described. For example, it could increase the perceived overall brightness of a virtual image beyond that possible from the display itself. For example, a signal could be sent to illuminate the frame at a high brightness when a virtual explosion appears on the display. Even if the display is limited in brightness, the frame could be made to flash very bright, and user could perceive this as being an overall brighter image.

The illumination of peripheral frame could also be controlled by processing the displayed image, or by sending separate control signals to the frame from the system.

The illumination of peripheral frame need not be continuous or equal around the perimeter. For example, just the lower portion of the frame could be illuminated, or the lower portion could be illuminated brighter than the upper portion or side portions. It could be segmented into more than just the four regions described. Accordingly, the illumination of peripheral light could be used to indicate images or activity that is outside the image displayed by the display. For example, if a sun is rising below the displayed field of view, the bottom portion of the frame could be illuminated to indicate a bright image below the field of view.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A virtual environment viewing device comprising:
a display;
an optics component oriented towards the display;
a housing connected to the display and the optics component and configured to exclude at least a portion of ambient light external to the housing; and
an illuminated frame connected to the housing and configured to illuminate a periphery of the display.

2. The virtual environment viewing device of claim 1, wherein the illuminated frame is positioned between the display and the optics component.

3. The virtual environment viewing device of claim 1, wherein the illuminated frame is positioned near the optics component and distal from the display.

4. The virtual environment viewing device of claim 1, wherein the illumination frame comprises a light emitting diode (LED) and a light conductive conduit.

5. The virtual environment viewing device of claim 1, wherein the illumination frame comprises an electroluminescent wire.

6. The virtual environment viewing device of claim 1, wherein the illumination frame comprises a light pipe.

7. The virtual environment viewing device of claim 6, wherein the light pipe redirects ambient light from outside of the housing.

8. The virtual environment viewing device of claim 6, wherein the light pipe redirects light from a backlight of the display.

9. The virtual environment viewing device of claim 1, wherein the illuminated frame comprises pixels in the periphery of the display.

10. The virtual environment viewing device of claim 1, wherein the illuminated frame comprises a polygonal shape.

11. The virtual environment viewing device of claim 1, wherein the illuminated frame comprises an elliptical shape.

12. The virtual environment viewing device of claim 1, wherein the illuminated frame comprises at least one point of light.

13. The virtual environment viewing device of claim 1, wherein a light production of the illuminated frame varies in response to a user command to move.

14. The virtual environment viewing device of claim 1, wherein a light production of the illuminated frame varies in response to a user movement.

15. The virtual environment viewing device of claim 1, wherein the illuminated frame further comprises a first portion configured to produce a first light, wherein a brightness of the first light is variable.

16. The virtual environment viewing device of claim 15, wherein the illuminated frame further comprises a second portion configured to produce a second light, wherein a brightness of the second light is variable independently from the brightness of the first light.

17. A head-mounted display comprising:
a display;
an optics component oriented towards the display;
a housing connected to the display and the optics component and configured to exclude at least a portion of ambient light external to the housing;
an attachment configured to attach the housing to a user's head; and
an illuminated frame connected to the housing and configured to illuminate a periphery of the display.

18. The head-mounted display of claim 17, wherein the illuminated frame produces a static light.

19. A stereoscopic head-mounted display comprising:
a left display;
a right display;
a left optics component oriented towards the left display;
a right optics component oriented towards the right display;
a housing connected to the left display, the right display, the left optics component, and the right optics component;
a left illuminated frame connected to the housing and configured to illuminate a periphery of the left display; and
a right illuminated frame connected to the housing and configured to illuminate a periphery of the right display.

20. The stereoscopic head-mounted display of claim 19, wherein the left illuminated frame and the right illuminated frame produce a static white light.
